(19) United States
(12) Patent Application Publication
(10) Pub. No.: US 2005/0051546 A1
(43) Pub. Date: Mar. 10, 2005

(54) Adjustable electrical box

(75) Inventor: Cong Thanh Dinh, Collierville, TN (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 10/656,433

(22) Filed: Sep. 5, 2003

(51) Int. Cl. H02G 3/08

(52) U.S. Cl. 220/3.7

(57) ABSTRACT

An adjustable electrical box including a box having a back wall bounded by a top and bottom wall and a pair of opposed sidewalls. The pair of sidewalls and the top and bottom walls are joined to form a continuous perimeter wall having an opening. A bracket is fixedly secured to the perimeter wall and extends outwardly therefrom for attaching said box to a support structure. A frame is telescopically received in said box opening. An adjustment device is rotatably secured to the frame and engagable with the perimeter wall of the box, wherein activation of the adjustment device causes the frame to move relative to the box.

### FIELD OF THE INVENTION

The present invention relates to an electrical outlet box, more specifically, an electrical box being adjustable to accommodate a variety of installation situations.

### BACKGROUND OF THE INVENTION

Electrical boxes are commonly employed in order to provide a termination for electrical connections to electrical components such as outlets and switches. Electrical boxes may be in the form of outlet boxes, junction boxes, floor boxes and switch boxes and may be located in walls, floors or ceilings or any location in which an electrical termination takes place. Electrical boxes are typically secured to a support structure such as a wall stud or ceiling joist and then covered with a covering material such as gypsum board, plaster, paneling or other type of covering material.

During new construction when electrical wiring is installed, electrical boxes are attached to the support structures in the desired location. When a box is secured to a support structure this typically fixes the position of the electrical box and does not provide for movement thereof. For proper installation, the front edge of the electrical box is typically desired to be substantially flush with the covering material. For interior construction, when wall covering material having standard thicknesses is used, such as gypsum board, electrical boxes may include a fixed offset such that the front of the box extends beyond the support structure a certain distance. Therefore, when the covering is attached the front of the box is substantially flush with the front surface of the wall covering. This fixed offset, however, requires that the installer know the thickness of the wall covering at the time of installation. The position can not be easily adjusted to accommodate for covering materials of irregular thickness or situations in which the covering thickness is changed after the electrical box is installed.

In order to accommodate changes or variations in covering thicknesses, various adjustable electrical boxes have been derived. U.S. Pat. No. 5,289,934 to Smith, et al. discloses an adjustable mounting assembly for an electrical outlet box. In this patent, the electrical box is attached to a bracket which moves relative to the electrical box. With the bracket fixed to the support structure, adjustment results in the entire box moving. Accordingly, installation of such a box requires an installer to ensure that there is enough play in the electrical wiring such that movement does not cause undue stress on the wiring.

U.S. Pat. No. 3,834,658 discloses an outlet box with an adjustable mounting. As in the '934 patent, the outlet box includes a bracket which is movably attached thereto. The bracket is fixably secured to a support structure such as a wall stud and the box may be moved relative to the bracket.

U.S. Pat. No. 5,042,673 is directed to an electrical box extension. The electrical box extension attaches to flanges located on a standard outlet box. In order to adjust the position of the extension, four (4) adjustment screws must be rotated in order to move the extension relative to the electrical box. Therefore, considerable effort must be employed in order to adjust the extension to the proper position. If a number of such boxes need to be installed in a job, the time and expense just for adjusting the extension becomes significant.

Accordingly, it would be desirable to provide an adjustable electrical box in which the outlet box remains fixed to a support structure and the front face of the assembly may be easily and quickly adjusted in order to be flush with the covering material.

### SUMMARY OF THE INVENTION

It is an advantage of the present invention to provide an electrical box having a degree of adjustability.

It is another advantage of the present invention to provide an electrical box having an electrical box fixedly secured to a support structure and a frame member movable relative thereto.

It is still another advantage of the present invention to provide an adjustable electrical box having an adjustment device disposed between the electrical box and the frame in order to affect relative movement therebetween.

In the efficient attainment of these and other advantages, the present invention provides an adjustable electrical box including a box having a back wall bounded by a top and bottom wall and a pair of opposed sidewalls. The pair of sidewalls and the top and bottom walls are joined to form a continuous perimeter wall having an opening. A bracket is fixedly secured to the perimeter wall and extends outwardly therefrom for attaching said box to a support structure. A frame is telescopically received in the box opening. An adjustment device is rotatably secured to the frame and engagable with the perimeter wall of the box, wherein activation of the adjustment device causes the frame to move relative to the box.

In a preferred embodiment, the adjustment device includes a member rotatably secured to the frame. The frame and the box include a cooperating projection and groove arrangement to guide movement of the frame relative to the box. The adjustment device may further include only one threaded member engagable with the box such that rotation of the one threaded member moves the frame between a fully retracted position and a fully extended position.

A preferred form of the adjustable electrical box, as well as other embodiments, objects, features and advantages of this invention will be apparent from the following detailed description of illustrative embodiments thereof, which is to be read in conjunction with the accompanying drawings.

### BRIEF DESCRIPTION OF THE DRAWINGS

FIG. 1 is top perspective view of an adjustable electrical box of the present invention.

FIG. 2 is an exploded top perspective view of the electrical box of FIG. 1.

FIG. 3 is an exploded first side perspective view of the electrical box of FIG. 1.

FIG. 4 is an exploded second side perspective view of the electrical box of FIG. 1.

FIG. 5 is a front elevational view the electrical box of FIG. 1 showing the adjustable electrical box attached to a support structure.

FIG. 6 is an elevational view of the electrical box of FIG. 1 showing the adjustable electrical box installed.

### DETAILED DESCRIPTION OF THE PREFERRED EMBODIMENTS

The present invention includes an electrical box for accommodating a variety of electrical components such as wires, outlets, switches, etc. The electrical box may be secured to a support structure such as a wall stud, which is typically covered by a material such as gypsum board, plaster or paneling. For proper instillation it is desirable to have the front of the electrical box to be generally flush with the front surface of the covering material. This permits a face plate to be properly placed on the box, which provides a secure covering to the box and its components. The electrical box of the present invention is adjustable to accommodate the variations in the support member and/or thickness in covering material such that the front of the box can be placed adjacent to the front surface of a wall covering material.

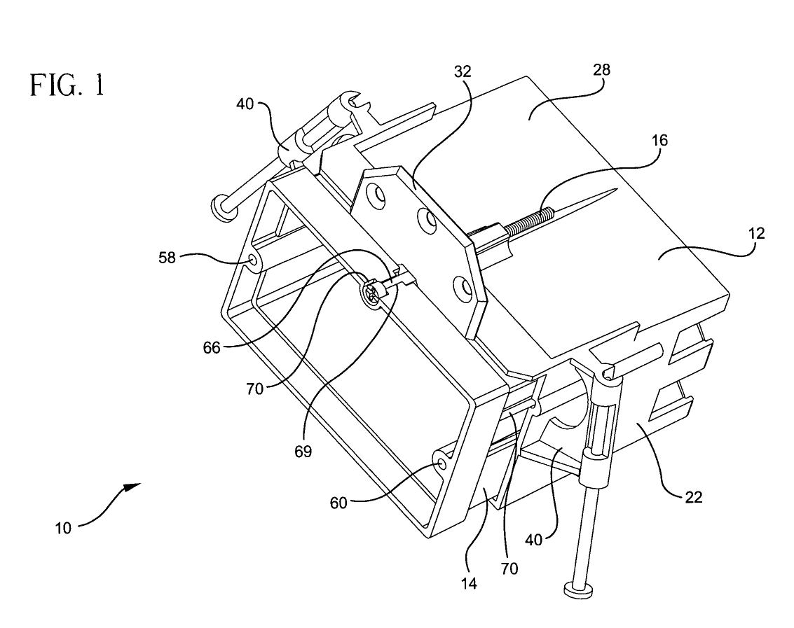

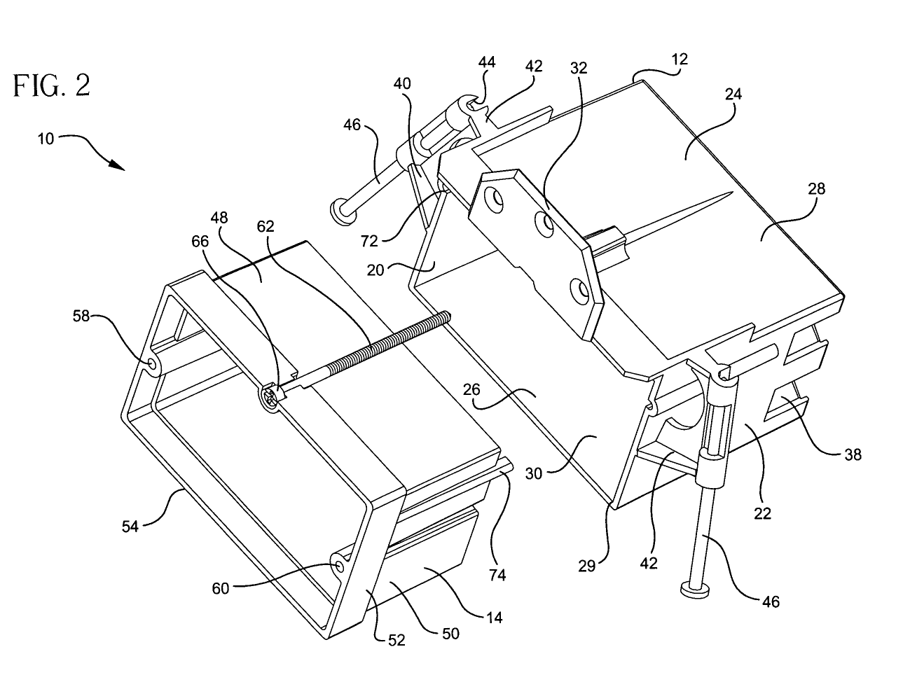

Referring to FIGS. 1 and 2, the adjustable electrical outlet box 10 includes a box 12 having a frame 14 telescopically received therein. An adjustment device 16 extends between the frame and box 12 and permits for movement of the frame relative to outlet box 12. Box 12 includes a back wall 18 bounded by a top wall 20 and bottom wall 22 and a pair of opposed sidewalls 24 and 26. The top, bottom and pair of sidewalls are joined together to form a continuous perimeter wall 28 ending in an edge 29. Edge 29 defines an opening 30 into which electrical components and/or wires may extend. Box 12 may be formed of a plastic or polymer material of the type typically used to make electrical boxes.

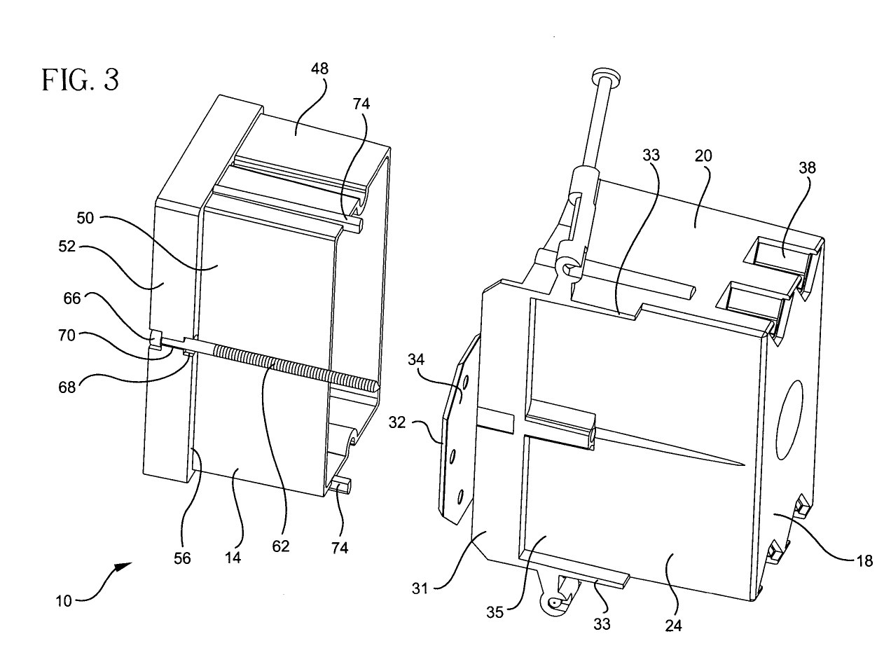

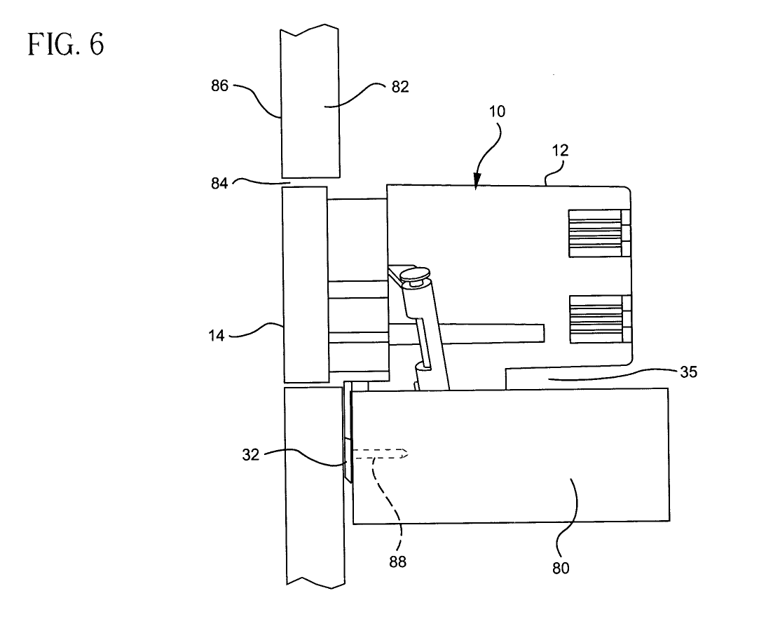

Referring additionally to FIGS. 3 and 6, sidewall 24 may include a flange 31 extending above edge 29. A mounting bracket 32 extends generally outwardly from flange 31. Mounting bracket 32 has a mounting surface 34 that abuts a support structure 80 when box 12 is mounted thereto. Bracket 32 includes a plurality of apertures 36 for accommodating mechanical fasteners. Mounting bracket 32 is configured such that it may be placed against the front of support structure 80, such as a wall stud, and be attached thereto with mechanical fasteners 88, such as screws and nails. In order to position box 12 against support structure 80, sidewall 24 may include a pair of standoffs 33, which cooperate with flange 31 to form a uniform mounting surface. Standoffs 33 and flange 31 project outwardly from sidewall 24 and provide a pocket 35 in which adjustment device 16 may extend. Box 12 may also include a plurality of knock-outs 38 formed on the perimeter wall. For example, the knock-outs 38 may be formed on the top and bottom wall 28 in order to permit electrical wiring to enter box 12.

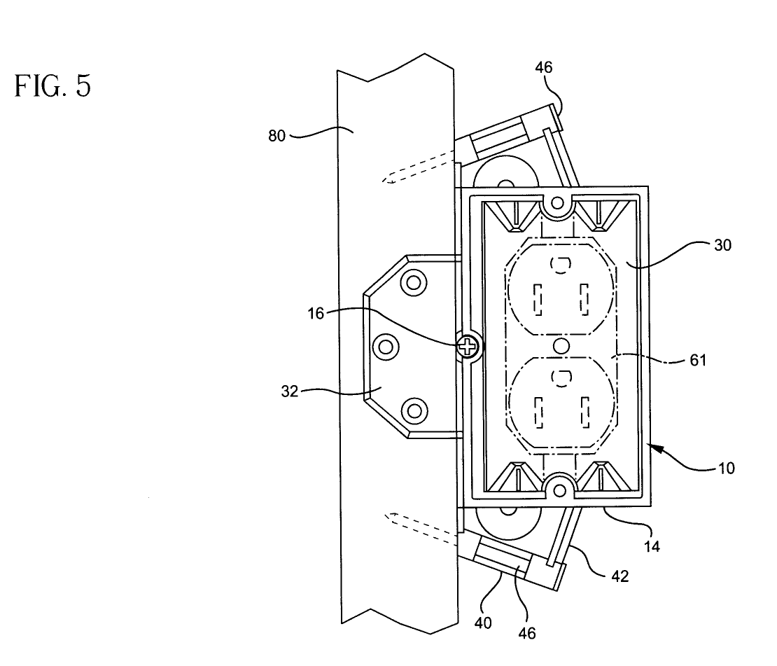

Referring to FIGS. 2 and 5, the present invention also provides an additional means of securing electrical box 12 to a support structure. Such securement device 40 includes a pair of ears 42 extending outwardly from the top 20 and bottom 22 of outlet box 12. The ears 42 include slots 44 which accommodate fasteners 46. Such fasteners may be frictionally held within slots 44. This frictional retention may be overcome by hammering fasteners 46 into support structure 44 upon installation.

Telescopically received within box opening 30 is frame 14. With reference to FIGS. 2-4, frame 14 has an outer wall 48 having a configuration substantially similar to the configuration of perimeter wall 28. For example, in the preferred embodiment, perimeter wall 28 and outer wall 48 both have a rectangular opening. However, it is in the contemplation of the present invention that the electrical box and frame may be formed in a variety of shapes. Outer wall 48 has a front 50 portion having a collar 52 which ends in a rim 54. Collar 52 extends outwardly from outer wall 48 forming a ridge 56. Located on the interior of outer wall 48 and adjacent rim 54 are a pair of electrical component attachment points 58. Attachment points 58 may include apertures 60 for receiving a threaded fastener in order to secure an electrical component 61 to frame 14 (FIG. 5).

In order to move frame 14 relative to outlet box 12, the present invention includes an adjustment device 16 extending therebetween. Adjustment device 16 is preferably disposed at a position between the top wall 20 and bottom wall 22 of box 12. In the preferred embodiment, adjustment device 16 includes a threaded member 62 rotatably secured to frame 14. Threaded member 62 extends from frame 14 and is threadedly received within an aperture 64 formed in sidewall 24 of electrical box 12. Aperture 64 may be integrally formed with sidewall 24. Rotation of threaded member 62 in one direction advances the threaded member into aperture 64 causing frame 14 to move in toward electrical box 12. Frame 14 may be moved into box 12 until frame ridge 56 engages perimeter wall edge 29 such that frame 14 is in a fully retracted state. In this retracted state, rim 54 is generally flush with mounting bracket front surface 34. Rotation in the opposite direction results in threaded member 62 moving out of aperture 64 resulting in frame 14 moving away from electrical box 12 to a fully extended state. Rotation may preferably be achieved by using a standard screwdriver, which engages threaded member 62. Adjustment device 16 in addition to permitting movement between box 12 and frame 14, retains frame 14 to box 12, such that the position of the frame is fixed relative to box 12, unless threaded member 62 is rotated.

With reference to FIGS. 1 and 3, threaded member 62 is preferably rotatably secured to frame 14 such that an upper portion 66 of threaded member 62 is disposed adjacent rim 54 to facilitate access thereto by an installer. In order to achieve the rotatable securement, a portion of collar 52 may be formed to include an indentation 68. Indentation 68 includes a slotted opening 69 which is adapted to permit the upper portion 66 of threaded member 62 to snap in to indentation 60 and be rotatably retained therein. The upper end or head portion 66 of threaded member 62 is generally flush with the front portion of frame 14 such that it is easily accessible by an installer even when covering material 82 is installed.

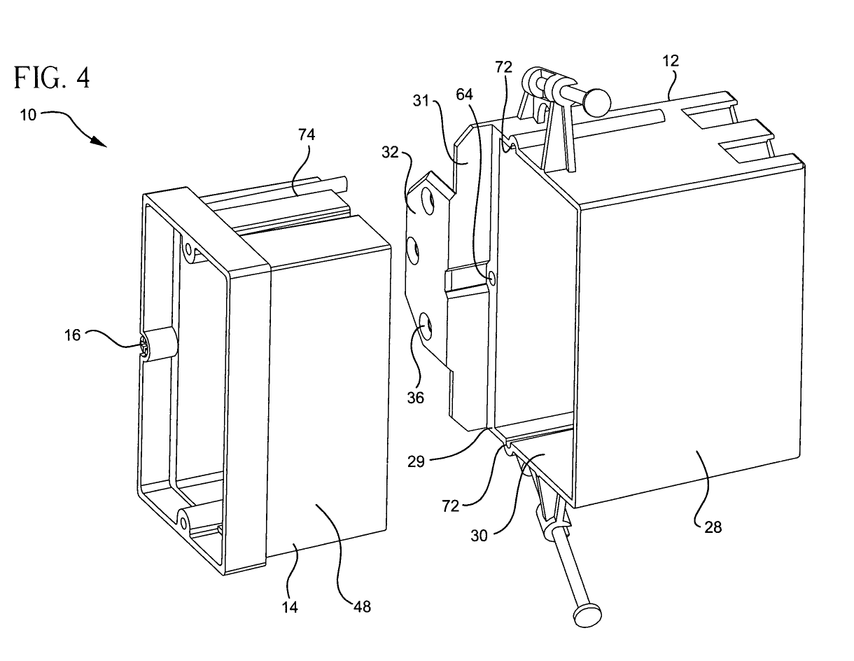

In order to assist in guiding the movement of frame 14 relative to electrical box 12, the present invention includes a guide 70 (FIG. 1). The guide 70 preferably includes a cooperating rail and slot arrangement. In the preferred embodiment shown in FIG. 4, electrical box 12 includes on the top and bottom wall 20, 22 a slot 72 extending from edge 29 toward back wall 18. Frame 14 includes on outer wall 48 a pair of rails 74 which are adapted to ride within slots 72. Guide 70 permits for uniform movement of frame 14 relative to electrical box 12 and assists in smooth operation when the adjusting member 16 is operated. It is within the contemplation of the present invention that the frame 14 could include the slots and box 12 could support the rails. It is also with in the contemplation of the present invention that frame 14 and box 12 could be configured with other cooperating structures so as to maintain alignment and insure proper operation.

In the preferred embodiment, only one threaded member is required in order to move frame 14 relative to box 12. The present invention by using only one member permits for fast and efficient method of adjusting the electrical box assembly 10. In contrast, devices of the prior art include as many as four (4) threaded members, each having to be rotated generally to the same degree in order to permit smooth movement of the telescoping member.

Referring to FIGS. 5 and 6, the adjustable electrical box of the present invention is preferably installed by positioning box 12 adjacent a support structure 80 such that mounting bracket 32 abuts the front face of support structure 80 fasteners such as nails or screws may be inserted in apertures 36 to secure box 12 to support structure 80. Fasteners 46 of securement device 40 may be driven into support structure further securing box 12. A covering material 82 such as gypsum board may be placed over the support structure 80. An opening 84 in covering material may be made to align with electrical box 10. Adjustment device 16 may be actuated to extend frame 14 such that rim 54 is substantially flush with a front surface 86 of covering material 80. The present invention permits the outlet box 12 to be fixedly secured to a support structure and only the frame moves. The bracket is fixed to the box; therefore, a sturdy connection to the support structure is achieved.

In the preferred embodiment, frame 14 is configured such that it may travel approximately 1 3/4 inches relative to box 12 without becoming removed from box 12. This dimension is for exemplary purposes only and is not intended to be limiting. This degree of movement permits electrical box assembly 10 to be used in a wide variety of applications since a variety of covering materials may be accommodated. In addition, the adjustment feature allows for variations in support member 80 and box 12 placement thereon to be accommodated. Once box 12 is secured to a support structure, an installer need not be overly concerned about the mounting depth of the box or the thickness of any covering material. Once the covering material is placed over the box with the appropriate opening formed in the covering material, the adjustment device 16 can be activated in order to extend or retract frame rim 54 such that it is flush with the front face of the covering material.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

1. An adjustable electrical box comprising:
a box including a back wall bounded by a top and bottom wall and a pair of opposed sidewalls, said pair of sidewalls and said top and bottom walls being joined to form a continuous perimeter wall having an opening;
a bracket fixedly secured to said perimeter wall and extending outwardly therefrom for attaching said box to a support structure;
a frame telescopically received in said box opening; and
an adjustment device rotatably secured to said frame and engagable with said perimeter wall of said box, wherein activation of said adjustment device causes said frame to move relative to said box.

2. The adjustable electrical box as defined in claim 1, wherein said adjustment device includes a member rotatably secured to said frame.

3. The adjustable electrical box as defined in claim 2, wherein said member is threaded and is threadedly secured to said perimeter wall.

4. The adjustable electrical box as defined in claim 3, wherein one of said pair of box sidewalls includes a threaded opening adapted to receive said threaded member.

5. The adjustable electrical box as defined in claim 4, wherein said threaded opening is integrally formed on said one of said pair of box sidewalls.

6. The adjustable electrical box as defined in claim 1, wherein said adjustment device is disposed at a point between said top wall and said bottom wall of said box.

7. The adjustable electrical box as defined in claim 1, wherein said frame and said box include a cooperating projection and groove arrangement to guide movement of said frame relative to said box.

8. The adjustable electrical box as defined in claim 7, wherein said bottom wall of said box includes said groove and a corresponding portion of said frame includes said projection.

9. The adjustable electrical box as defined in claim 1, wherein said frame is adapted to be secured to an electrical component.

11. The adjustable electrical box as defined in claim 9, wherein said frame includes a sidewall having a collar ending in a rim, and said collar extends outwardly beyond said sidewall.

12. The adjustable electrical box as defined in claim 1, wherein said adjustment device includes only one threaded member engagable with said box.

13. The adjustable electrical box as defined in claim 1, wherein said frame include a pair of opposed securement points adapted to secure an electrical component to said frame.

14. The adjustable electrical box as defined in claim 1, wherein said box perimeter wall ends in an edge and said edge supports said collar when said frame is in a fully retracted state.

15. An adjustable electrical box assembly comprising:
a box including a back wall bounded by a top and bottom wall and a pair of opposed sidewalls, said pair of sidewalls and said top and bottom walls being joined to form a continuous perimeter wall having an opening;
a frame telescopically received in said opening; and
an adjustment device for causing said frame to move relative to said electrical box between a fully retracted position and a fully extended position, said attachment device including at least one threaded member rotatably secured to said frame and threadedly received in one of said pair of sidewalls of said electrical box.

16. The adjustable electrical box as defined in claim 15, wherein said frame and said box includes a cooperating projection and groove arrangement to guide movement of said frame relative to said box.

17. The adjustable electrical box as defined in claim 16, wherein said bottom wall of said box includes said groove and a corresponding portion of said frame includes said projection.

18. The adjustable electrical box as defined in claim 15, wherein said frame includes an electrical component attachment point adapted to secure an electrical component thereto.

19. The adjustable electrical box as defined in claim 15, wherein said adjustment device retains said frame to said box.

20. The adjustable electrical box as defined in claim 16, wherein said threaded member includes a top portion disposed adjacent said rim.
